(19) United States
(12) Patent Application Publication
(10) Pub. No.: US 2012/0244507 A1
(43) Pub. Date: Sep. 27, 2012

(54) Learning Behavior Optimization Protocol (LearnBop)

(76) Inventors: Arthur Tu, Pittsburgh, PA (US); Bharanidharan Rajakumar, Miami, FL (US)

(21) Appl. No.: 13/052,623

(22) Filed: Mar. 21, 2011

(51) Int. Cl. G09B 7/00

(52) U.S. Cl. 434/362

(57) ABSTRACT

According to certain aspects of some embodiments, LearnBop is both a conceptual and a logical design for a two-way, reciprocating learning platform and community where users can create, consume, critique, review learning progress and improve learning content.

### TECHNICAL FIELD

The present invention is directed to online learning, and more specifically to an interactive and adaptive learning environment with knowledge-centered componentization.

### BACKGROUND

FIG. 1 is a general data flow diagram of a conventional intelligent tutoring system.

FIG. 1 shows tutoring system 100 comprising knowledge model/domain module 102, learning interface 104, problem graph 108 and tracing engine 106.

While such construction poses a good analogy of a “knowledgeable” human tutor that reacts to students' queries with appropriate conceptual feedback, such a concept of a tutoring system results in a complex and often disorderly design of the tracing engine 106 that needs to communicate with both the domain module 102 and the learning interface 104, which often have no standardized one-to-one mapping between knowledge and user interactions. There are a number of downsides to this conventional concept of intelligent tutoring systems since they are: 1) Difficult to organize, due to the knowledge and interface modules' independence from each other. Any change made to the knowledge module will not automatically produce relevant interface components, and vice versa; 2) Inefficient to execute and operate, as the knowledge module runs a separate process from the interface module in processing student input. Independent knowledge and interface modules communicating in parallel may depend on allocation of additional computer and networking resources (e.g., thread, communication port); 3) Non-modular—with separate modules and processes, it is difficult to take a particular intelligent tutoring problem and extract and recombine constituent knowledge and steps; 4) Non-reusable—since neither the knowledge module nor the interface module fully define the conceptual entirety of the problem, the intelligent tutor may not be easily ported to other platforms (e.g., smart phones, tablets, kiosks, e-readers, portable gaming consoles) without rewriting one or more of the knowledge module, the interface module or the tracing engine in order to re-define the relationships between knowledge and interface interactions.

### BRIEF DESCRIPTION OF THE DRAWINGS

FIG. 1 is a general data flow diagram of a conventional intelligent tutoring system.

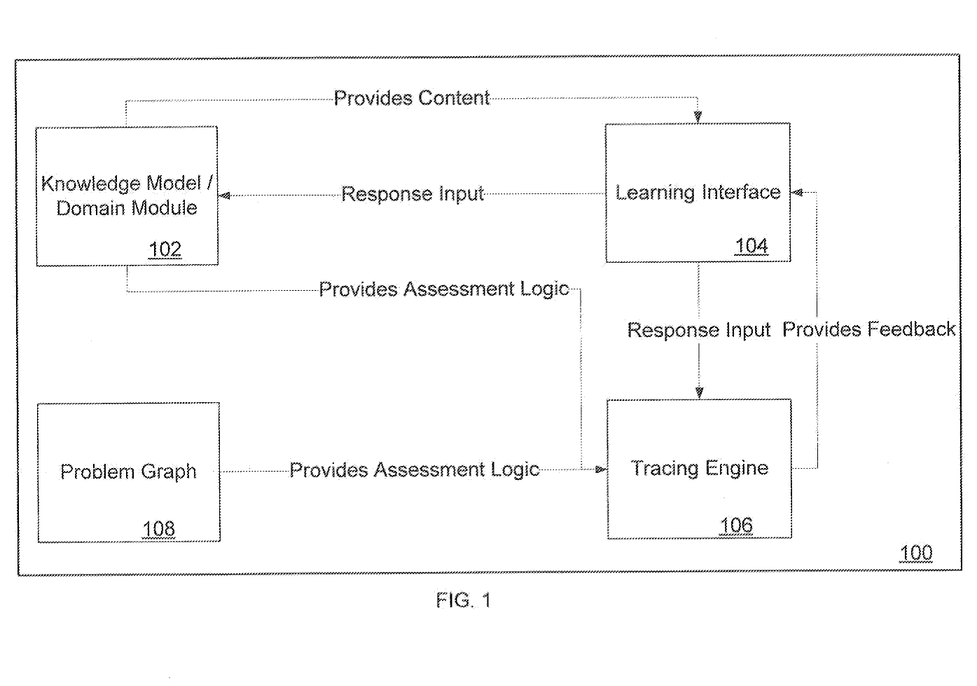

FIG. 2 is a high-level data flow diagram that illustrates an overview of the CKALE paradigm and the design of the LearnBop platform, according to certain embodiments.

FIG. 3 illustrates the design architecture of an interaction knowledge component, according to certain embodiments.

FIG. 4 illustrates a high-level logical design of a lesson on the LearnBop platform, according to certain embodiments.

FIG. 5 is an example of rich-text content authored for use in a LearnBop adaptive lesson, according to certain embodiments.

FIG. 6 illustrates an instructional scaffolding example, according to certain embodiments.

FIG. 7 illustrates another instructional scaffolding example, according to certain embodiments.

FIG. 8 illustrates creating a representation using the authoring process, according to certain embodiments.

FIG. 9 illustrates conceptual labeling in the authoring process, according to certain embodiments.

FIG. 10 illustrates designation of interaction knowledge components, according to certain embodiments.

FIG. 11 illustrates populating Interaction knowledge components, according to certain embodiments.

FIG. 12 illustrates the rendering of a given representation into an adaptive lesson, according to certain embodiments.

FIG. 13 illustrates an example of a hint request button, according to certain embodiments.

FIG. 14 illustrates the use of a modal message, according to certain embodiments.

FIG. 15 illustrates a progress display, according to certain embodiments.

FIG. 16 illustrates instructional scaffolding, according to certain embodiments.

FIG. 17 illustrates the use of focus grabbers, according to certain embodiments.

FIG. 18 illustrates Focus-Sensitive Problem-Solving Step #1, according to certain embodiments.

FIG. 19 illustrates Focus-Sensitive Problem-Solving Step #2, -according to certain embodiments.

FIG. 20 is a graph illustrating the amount of time each user/learner spent on the lesson, according to certain embodiments.

FIG. 21 illustrates a Conditional and Correlational Analysis Example—Hint Effectiveness, according to certain embodiments.

FIG. 22 illustrates a sample Motivation and Strategy for Learning Questionnaire, according to certain embodiments.

FIG. 23 illustrates a Help-Seeking Behavior Reporting Example—Hints Requests vs. Intrinsic Motivation, according to certain embodiments.

FIG. 24 illustrates Predicting Future Help Needs—Decision Tree, according to certain embodiments.

FIG. 25 illustrates a sample Causal Model of Learning, Motivation and Help-Seeking, according to certain embodiments.

FIG. 26 shows data flow of the system 2600 per interaction knowledge component, according to certain embodiments.

FIG. 27 illustrates a Service-based Client Design, according to certain embodiments.

FIG. 28 illustrates an Offline Client Design, according to certain embodiments.

### DETAILED DESCRIPTION

### A New Adaptive Learning Environment With Knowledge-Centered Componentization

According to certain embodiments, Learning Behavior Optimization Protocol (LearnBop) is a componentized learner-, knowledge- and skill-centered, motivationally- and metacognitively-enhanced learning platform design that allows explanation-driven, representation-sensitive and context-sensitive authoring to create learning content for use on personal computers, mobile devices as well as on devices without network connectivity. According to certain aspects of some embodiments, LearnBop is both a conceptual and a logical design for a two-way, reciprocating learning platform and community where users can create, consume, critique, review learning progress and improve learning content.

Componentized, knowledge-centered adaptive learning environment (CKALE), is a method for creating responsive knowledge that adapts to incorrect or correct responses, according to certain embodiments. CKALE has been implemented as the LearnBop Platform.

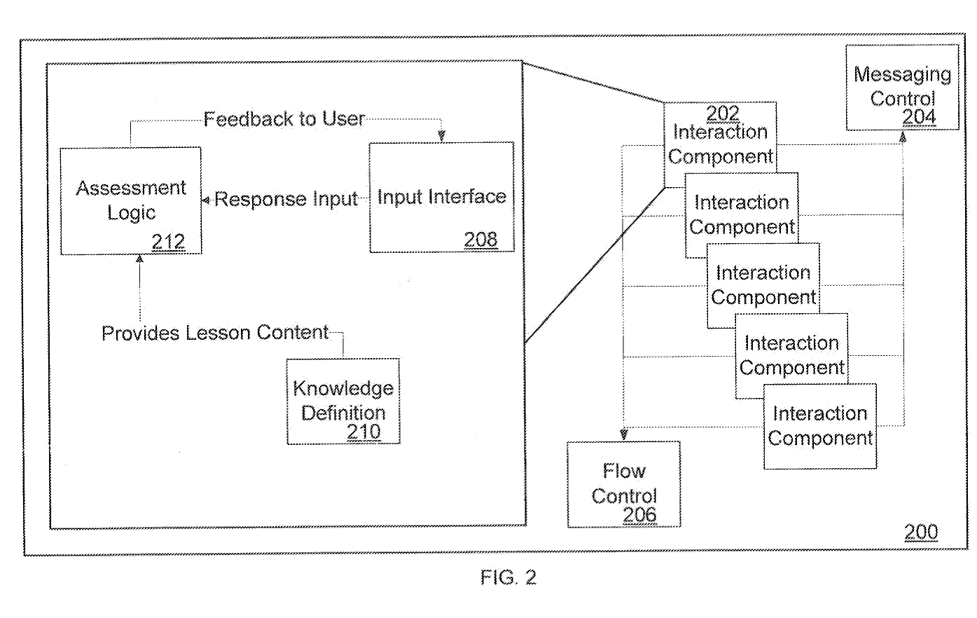

FIG. 2 is a high-level data flow diagram that illustrates an overview of the CKALE paradigm and the design of the LearnBop platform, according to certain embodiments.

FIG. 2 illustrates the LearnBop platform as a learning environment 200 constructed by small building blocks called interaction knowledge components 202 and includes problem flow control 206 and messaging control 204, according to certain embodiments. Interaction knowledge components 202 resemble both conceptual and software sub-components of a learning exercise. The interaction knowledge component 202 is an independent, severable unit of instruction and learning interaction that can provide feedback to students through messaging control 204, or can be chained together to form more complex problems with problem flow control 206. Interaction knowledge component 202 includes input interface 208, assessment logic 212 and knowledge definition 210.

In short, traditional intelligent tutoring systems are divided into holistic modules and exchange information between modules in holistic manners. For instance, a problem graph defines correct inputs based on states of the interface. Thus, a simple input like “5” as an addition operand at different times may have different prior states. Similarly, a domain module may use certain rules and logic to evaluate certain fields of the interface, and even though two fields on the interface demonstrate the same skill, the rules in the domain module need to be distinctly bound (or hook) to every input field. Many concerns like the ones mentioned here that arise from interactions of holistic modules in traditional intelligent tutoring systems, make problem authoring extremely difficult to generalize and authored problems hard to reuse within and across different platforms.

In contrast, the CKALE methodology takes on the requirements of generalized, flexible problem authoring and reusable authored problems more easily: every interaction knowledge component contains compact interface manifestation and assessment logic to represent the evaluation of knowledge in the form of a single input. Therefore, no software interface component on the screen is without a direct mapping to associated knowledge. Such a design allows the same concepts and skills in a learning problem to be reused by simply adding an interaction knowledge component and without having to create additional bindings or hooks between the interface and domain modules or problem graphs. Furthermore, as long as a new platform implements the set of LearnBop interaction knowledge components, a problem authored on the LearnBop platform can be reproduced on the new platform without explicit modifications.

The CKALE paradigm sets a new standard for adaptive learning where learning environments and learning systems are constructed with complete coherence to the conceptual construction of the topic of instruction, as opposed to traditional intelligent tutoring systems, where software systems function and interface with domain modules as separate processes.

The CKALE paradigm and the design of the LearnBop platform comprise the following:

Interaction knowledge components, are compact reusable, regroupable modules that fully define the relevant domain knowledge (e.g., what is the coefficient of a term 3×), the visual manifestation of the knowledge on the interface (e.g., a problem prompt complemented with a textbox input), as well as all control logic to evaluate correctness and provide instructional scaffolding. Therefore, an interaction knowledge component as a modular encapsulation of knowledge serves as a fundamental building block to complex problem solving and problem authoring, allowing one to divide or combine problems and study learning content in part, in whole or in conglomerates.

Behavior Optimization Protocol Definition Language, or BOP definition language (BDL), is a high level mark-up language used to initialize, order, chain and populate interaction knowledge components in order to fully define learning interactions in adaptive lessons. Since interaction knowledge components may have slightly different implementations on different platforms (e.g., desktop computers vs. tablets), the BDL serves as an important underlying foundation to lesson generation since it provides a standardized way of describing interactions, making the same adaptive lesson reusable across different media without explicit modification.

Learning Environment Interface is a generic visual environment that houses the interfaces and interactions produced by CKALE. The learning environment interface assumes several requirements, including means to request hint, movable windows, attention grabbers and modal window locks.

Knowledge-centered, representation-sensitive authoring process, is one that uses a What-You-See-Is-What-You-Get (WYSIWYG) style visual manipulation tool to create adaptive lessons without requiring the user to explicitly create BDL definitions. The authoring process emphasizes visual manifestation of superset and subset relations. In other words, interaction knowledge components may be dropped into a color-coded concept container, and will then be treated as a conceptual whole that the platform will present and scaffold holistically.

Knowledge Discovery as a Service (KDS) provides state-of-the-art analysis and reporting services from the learning sciences, to any instructors that deploy classes on a CKALE system. Instead of presenting bare statistics and reports on the raw data (e.g., raw student inputs, correctness of answers) generated by the system, CKALE system performs machine learning on all the learning behaviors that took place on the learning platform, and present instructors highly refined models that predict student performance and learning style, so as to help the instructor discover specific learning patterns.

Adaptive Learning as a Service (ALS), is an cloud-computing metaphor for education where through distributed computing apparatuses, BDL-defined adaptive lessons can turn web services (and distributed computing as well as local computing apparatuses alike) into learning resource and instructional scaffolding providers. A wide range of devices with or without network connectivity can deliver full-fledged adaptive learning experience to learners in a wide-range of developed and underdeveloped social and infrastructural settings, supplying true ubiquitous learning.

The CKALE paradigm is one where computerized knowledge can be divided, joined, regrouped and reused effectively and efficiently, allowing for adaptive learning over a wide range of networks and computing devices.

The following sections contain the designs for each of the constituent modules of the LearnBop system: Interaction knowledge components, Bop Definition Language, Authoring Process, Knowledge Discovery and Adaptive Learning as a Service.

### Interaction Knowledge Components

An interaction knowledge component is a fundamental building block in a componentized, knowledge-centered adaptive learning environment that resembles both a sub-concept/sub-skill resulting from cognitive task analysis in the learning sciences, and a software design architecture.

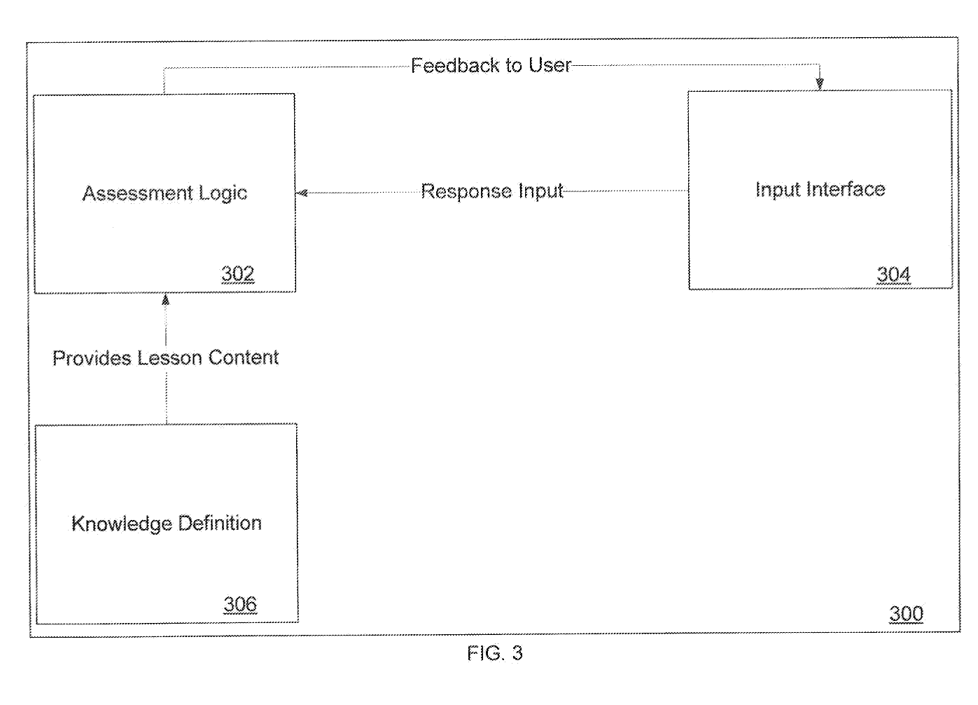

FIG. 3 illustrates the design architecture of an interaction knowledge component, according to certain embodiments.

As illustrated in FIG. 3, interaction knowledge component 300 includes an input interface 304, an assessment logic 302, and a knowledge definition 306.

Input interface 304 is a visual manifestation of the interaction knowledge component that provides the user with a prompt (video, audio or other media) and software interface components (textboxes, radio buttons, drop-down lists, drag-and-drop lists or other interface elements).

Assessment logic 302 is responsible for evaluating user input. Interaction knowledge component 300 may have multiple correct answers; for each correct answer there may be a different success feedback message; for each incorrect answer there may be a different error message; each interaction knowledge component may also provide a variable number of hints that the learner can request.

Knowledge definition 306 provides the content that will populate the prompt and input controls on the interface, and to the assessment logic to evaluate correctness of inputs.

The input interface and the assessment logic provide an abstract, reusable building block for interactive knowledge representation that is later populated by specific knowledge definitions.

### Concept Grouping and Tagging

As described previously, an interaction knowledge component is capable of evaluating a granular conceptual or skill step such as adding, subtracting or citing a fact (the list is by no means exhaustive). However, many more complex skills such as derivation, integration, tracing graph tours, calculating conditional probabilities, may require multiple granular steps to complete.

Therefore, it is often beneficial to organize interaction knowledge components into concepts that describe complex skills. The role of concepts is similar to the interaction knowledge component. It is a building block that can be reused and regrouped both in conceptual grounds and in software engineering.

The following is an example of a complex skill organized by a concept:

3(2+5)=6+15

As shown above, the skill of integer multiplication involves distributing the 3 and multiplying it by 2 and 5 respectively. In other words, the skill described here requires two interaction knowledge components to demonstrate. Hence, the individual interaction knowledge components and overall concept in this example are tagged accordingly.

### Lesson Exercise Sequence

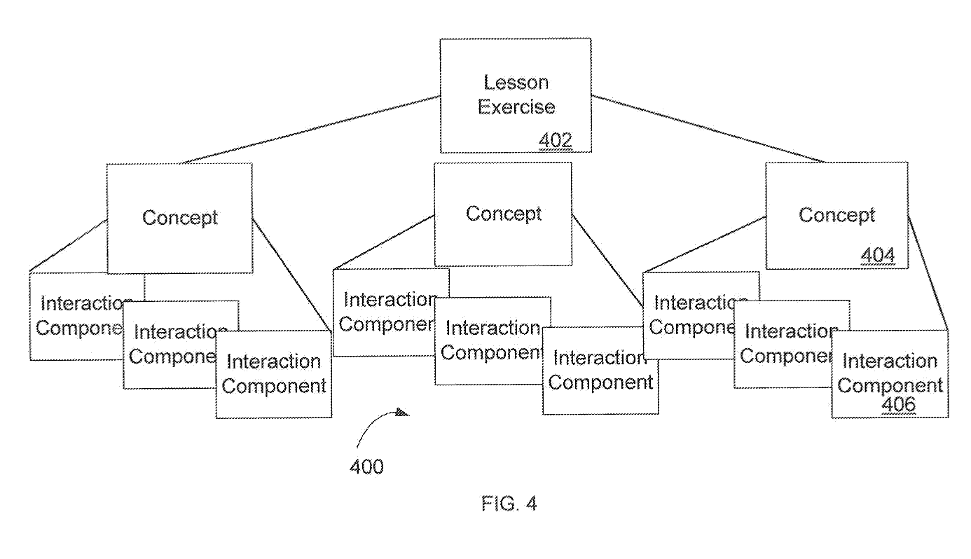

A typical practice problem in learning and in education often involves multiple concepts. FIG. 4 illustrates the logical design 400 of a lesson on the LearnBop platform (number of items shown in the diagram does not resemble any physical limitation of the system), according to certain embodiments.

FIG. 4 shows Interaction knowledge component chaining and problem formation (lesson exercise 402). FIG. 4 shows that interaction knowledge components 406 may function as independent incremental steps in a problem, but they can be chained together either into one problem, or into multiple concepts 404 that form one problem/lesson exercise 402.

### Behavior Optimization Protocol Definition Language

As described previously, interaction knowledge components may be grouped to form concepts and exercises. In order to achieve such a degree of reusability and flexibility, the CKALE paradigm includes the use of a generalized definition language to specify the content of a lesson.

A plausible but not the only implementation of such a definition language is XML that can be used to define a lesson exercise, like so:

### Example 1

```
  <Lesson>
    <Exercise>
      <Name>Calculus Practice</Name>
      <DefaultHintMessage>Default Hint for the entire
lesson.</DefaultHintMessage>
      <DefaultErrorMessage>Default Error for the entire
lesson.</DefaultErrorMessage>
        <Concept>
          <Name>Arithmetic</Name>
          <DefaultHintMessage>Default Hint for the concept:
Arithmetic</DefaultHintMessage>
          <DefaultErrorMessage>Default Error for the concept:
Arithmetic</DefaultErrorMessage>
          <Component>
            <TextBox>
              <Prompt>Enter the missing value</Prompt>
              <HintMessage>Add the integers together.
              </HintMessage>
              <HintMessage>What is 3+2?</HintMessage>
              <Input>
                <Value>5</Value>
                <IsCorrect>true</IsCorrect>
                <SuccessMessage>Good Job!</SuccessMessage>
              </Input>
            <DefaultErrorMessage>Add the integers 3 and 2.</
DefaultErrorMessage>
            </TextBox>
          </Component>
        </Concept>
        <Concept>
          <Name>Derivatives</Name>
          <DefaultHintMessage>Default Hint for the concept:
Derivatives</DefaultHintMessage>
          <Component>
            <TextBox>
            <Prompt>Enter the missing value</Prompt>
            <HintMessage>To derive an algebraic expression,
multiply the exponent by the coefficient and subtract the
exponent by one.</HintMessage>
            <Input>
              <Value>15</Value>
              <IsCorrect>true</IsCorrect>
              <SuccessMessage>Good Job!</SuccessMessage>
            </Input>
            <Input>
              <Value>10</Value>
              <IsCorrect>false</IsCorrect>
              <ErrorMessage>This is incorrect, multiply 5 by 3
here.</ErrorMessage>
            </Input>
            <ErrorMessageDefault>This is incorrect.
            </ErrorMessageDefault>
          </TextBox>
        </Component>
        <Component>
          <MultipleChoice>
            <Prompt>Enter the missing value</Prompt>
            <HintMessage>When deriving an algebraic expression,
subtract 1 from the exponent</HintMessage>
            <Input>
              <Value>2</Value>
              <IsCorrect>true</IsCorrect>
              <SuccessMessage>Good Job!</SuccessMessage>
            </Input>
            <Input>
              <Value>3</Value>
              <IsCorrect>false</IsCorrect>
              <ErrorMessage>You forgot to subtract the
exponent, 3, by 1.</ErrorMessage>
            </Input>
            <ErrorMessageDefault>This is incorrect.
            </ErrorMessageDefault>
          </MultipleChoice>
        </Component>
      </Concept>
    </Exercise>
  </Lesson>
```

The above markup outlines a definition written in a XML-based implementation of the BOP definition language. The example outlines a small derivative problem with two sets of interaction knowledge components, the first set demonstrating the concept and skill of arithmetic operations, and the second set demonstrates the concept of derivatives. As can be seen in the example, the lesson may contain exercises, which in turn contain concepts and interaction knowledge components. One can define the default hint and error message at each of the different hierarchical levels described above. One can also create hint messages for every interaction knowledge component, or error messages for every input value that is handled by the interaction knowledge component. The example also contains definitions for two types of inputs, textboxes and multiple choices.

The example is by no means exhaustive of the possibilities, as it is presented to demonstrate the immense flexibility and reusability suggested by the CKALE paradigm where concepts and skills in learning can be regrouped, joined and divided.

### Authoring Process

According to certain embodiments, techniques are provided for generating an adaptive lesson, which adaptive lesson is constructed by an instructor without requiring any knowledge of computer programming and only requiring access to the internet. The instructor-developed lessons are learner and knowledge specific and fully specify the conceptual or skill-based knowledge points that a learner must focus on via interaction knowledge components.

### Lesson Content Authoring

Using the authoring process, instructors can create a complete lesson tailored to a student's specific interests. The curriculum designer scaffolds curriculum design for the instructor in a step-by-step manner.

### Rich-Text and Multimedia Content

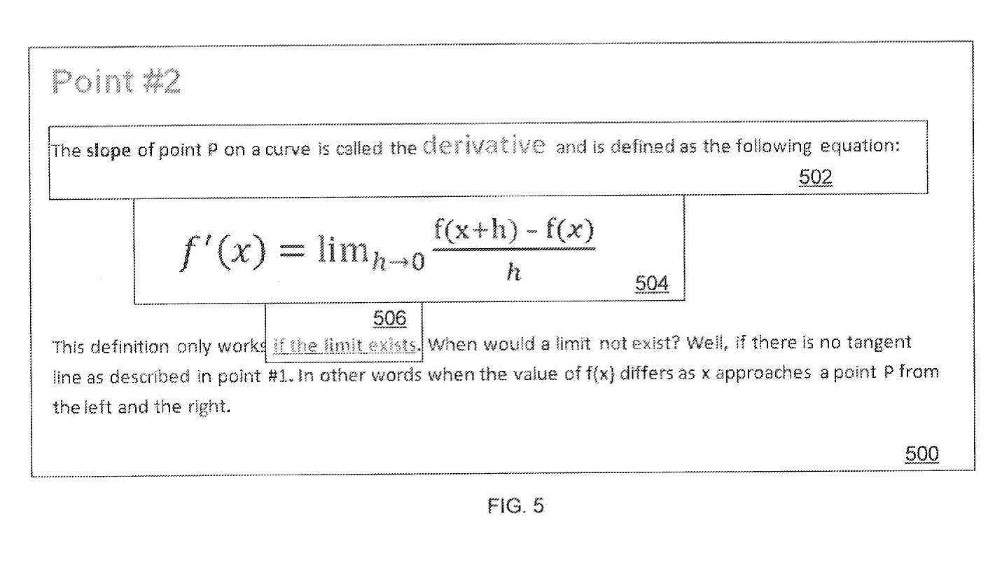

In numerous cases, the instructor authoring the bop may wish to include static lesson content for students to consume before starting an exercise. The LearnBop platform authoring process therefore includes a WYSIWYG (What you see is what you get) editor for creating rich-text and multimedia lesson content that can be included in and deployed as a part of an adaptive lesson for delivering a fuller learning experience. FIG. 5 is an example of rich-text content authored for use in a LearnBop adaptive lesson, according to certain embodiments.

FIG. 5 shows rich-text content example 500 that illustrates definition 502 of “slope” on a curve, derivative equation 504 and explanation 506.

### Instructional Scaffolding

In accessing static content, instructional scaffolding that provides additional context-specific learning content upon request are often beneficial to learning. The LearnBop platform lesson content authoring tool provides means for an instructor to highlight part of the rich-text multimedia content and provide additional, optional scaffolding information for target learners.

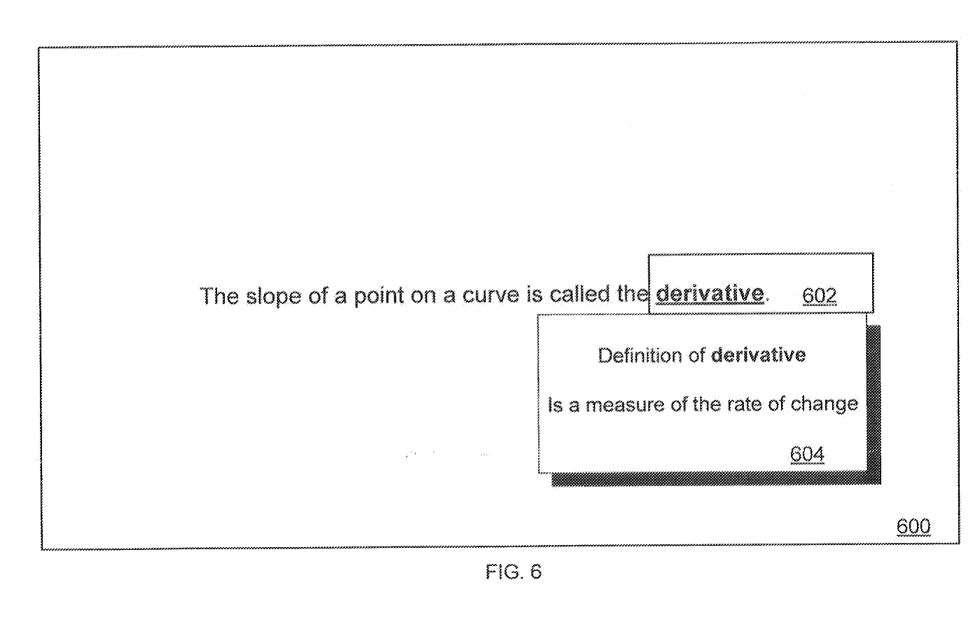

For example, FIG. 6 illustrates an instructional scaffolding example, according to certain embodiments. FIG. 6 shows a lesson snapshot 600 with the definition 604 of the term “derivative” 602 inserted and requested.

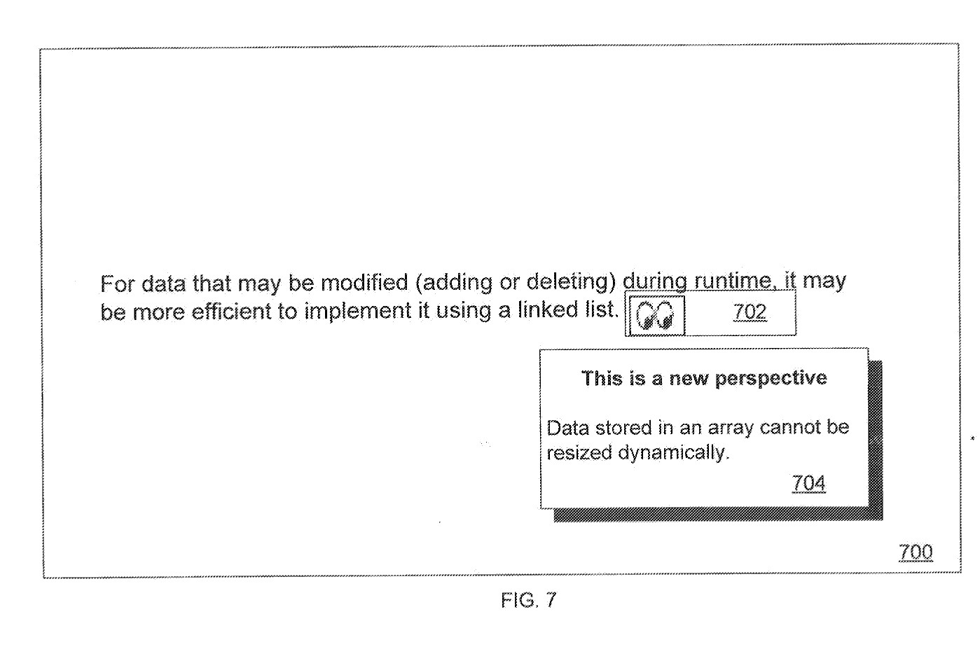

FIG. 7 illustrates another instructional scaffolding example, according to certain embodiments. FIG. 7 shows a lesson snapshot 700 with an additional scaffolding message 704 to help the learner understand a new way of looking (702) at a problem.

### Visual Authoring Process

Once the curriculum design process has collected sufficient information to guide the lesson authoring process, a visual authoring process is initiated to help teachers rapidly create adaptive lessons without programming or design work.

As discussed previously, an interaction knowledge component is a modular component that encapsulates interface components necessary to demonstrate and manifest a concept visually (e.g., radio buttons and a submit button for multiple choice), as well as associated conceptual knowledge (e.g., hints, error messages, prompts, etc) required to scaffold a student to successfully complete the problem or recover from errors. Thus, an interaction knowledge component not only acts as a building block for the interface, it is also a representation of a step in a problem-solving process. A concept on the other hand subsumes one or more interaction knowledge components to illustrate a more complex concept or skill in learning.

In order to allow creation of complex adaptive lessons without design or programming experience, the LearnBop architecture incorporates a visual authoring process in the CKALE paradigm to serve as guidelines for authoring tools for adaptive learning problems.

The CKALE authoring process design is grounded in a WYSIWYG (what you see is what you get) interface where visual representations can be manipulated by dragging-and-dropping, and information may be inputted through the keyboard.

In overview, the adaptive authoring process is divided into a number of phases as follows, according to certain embodiments:

### Creating a Representation

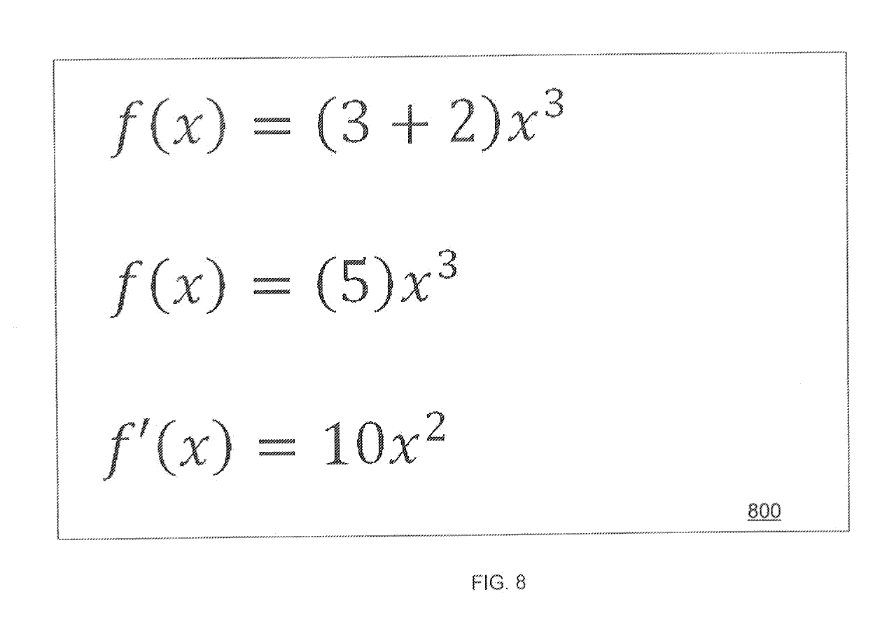

By using visual tools such as ink-based/touch-based drawing, graphics manipulation, equation editors, etc, an instructor/author can create a representation that illustrates the content of the problem. FIG. 8 illustrates creating a representation using the authoring process, according to certain embodiments.

For example, to create a derivative problem that resembles what was described in the BOP definition language section, an author/instructor may create a representation 800 as shown in FIG. 8.

### Labeling Concepts

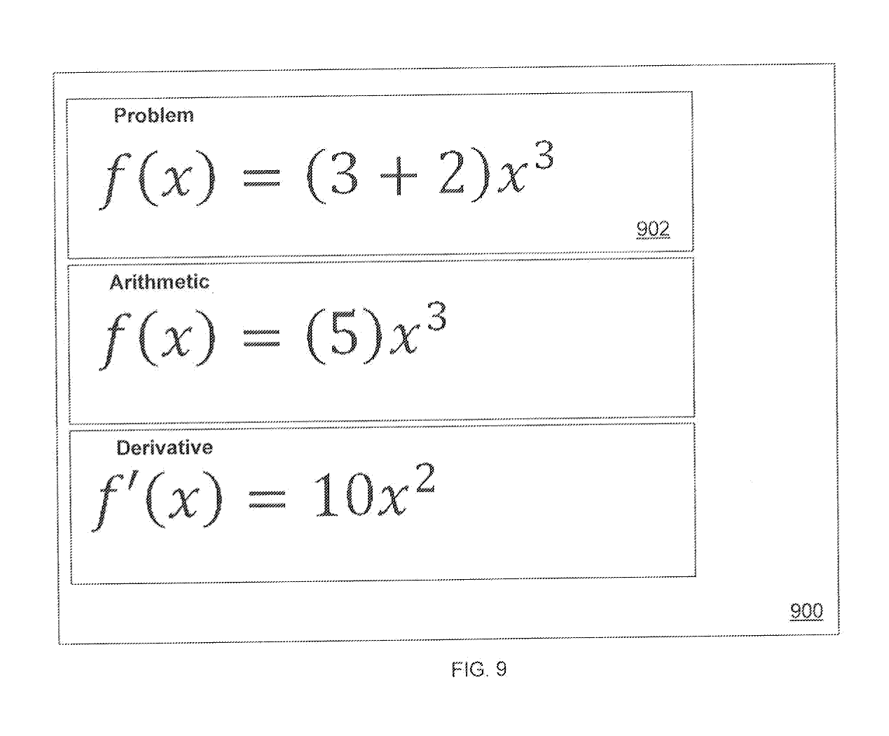

An instructor can use one or more resizable, color-coded labels to select part of the presentation that demonstrate particular concepts or skills. FIG. 9 illustrates conceptual labeling in the authoring process, according to certain embodiments.

To illustrate, following the example used previously in FIG. 8, an instructor/author may label concepts using color-coded blocks 902 for representation 900 in FIG. 9.

### Designating Interaction Knowledge Components

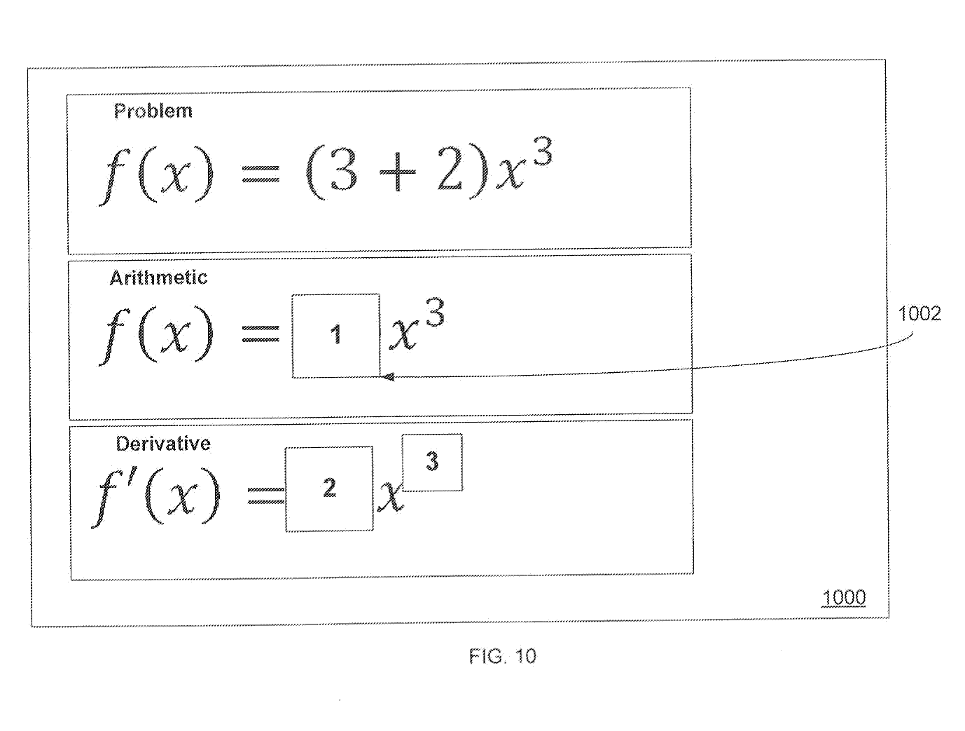

FIG. 10 illustrates designation of interaction knowledge components, according to certain embodiments. The author/instructor may use resizable, color-coded labels 1002 to designate interaction knowledge components, transforming the representation 1000 into an adaptive problem.

### Populating Interaction Knowledge Components

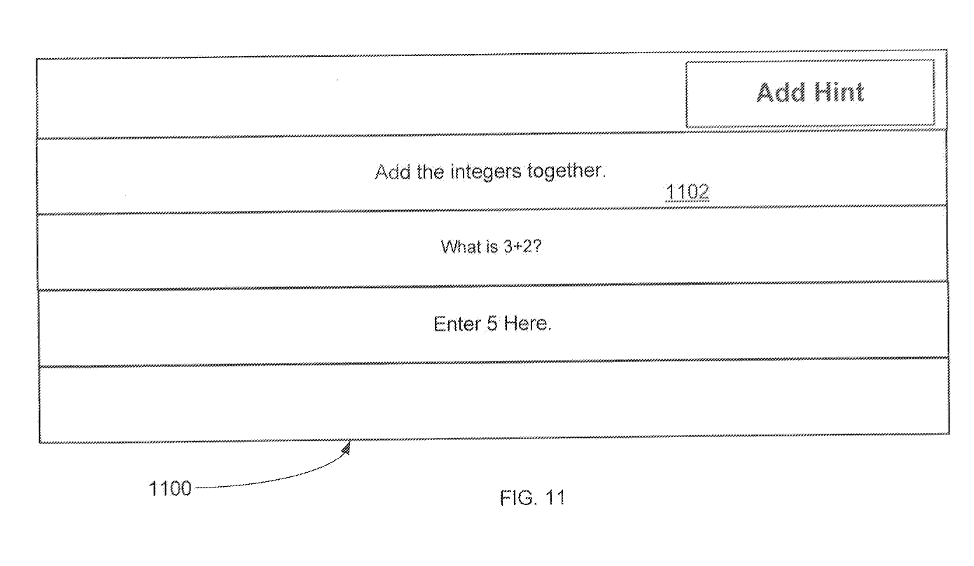

FIG. 11 illustrates populating Interaction knowledge components, according to certain embodiments. The author/instructor may use visual forms and other common user interface controls to populate information for the interaction knowledge component that have been added to the lesson.

For example, FIG. 11 shows that the author may populate the hint messages by adding the messages 1102 to the list 1100.

Publishing the Visual Content into Bop Definition Language

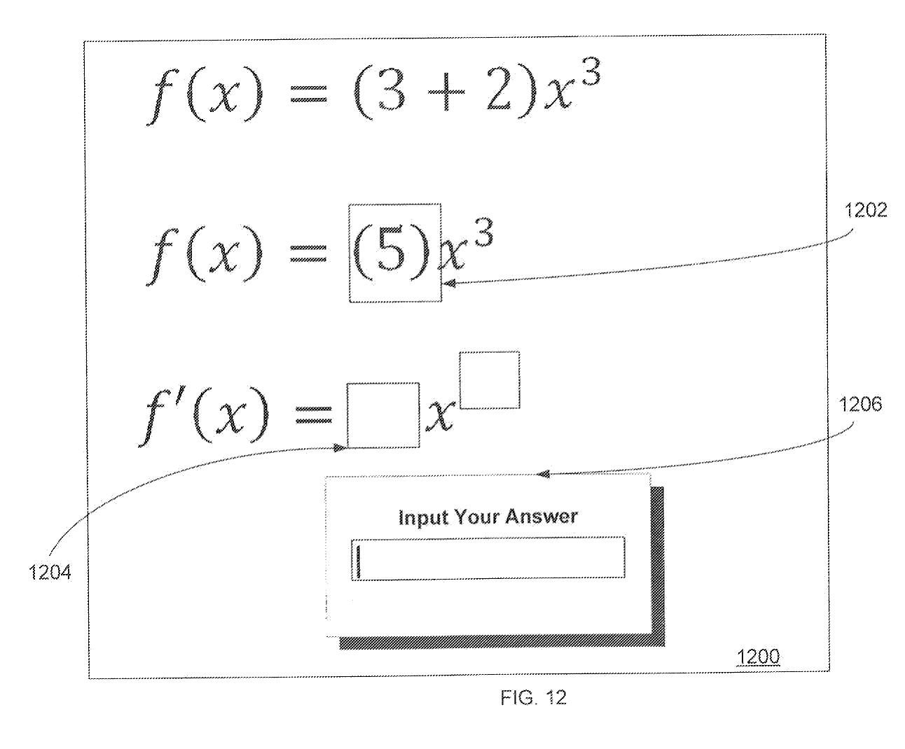

Upon completing the creation of the lesson, the author may publish the lesson to BOP definition language. The process of publishing is straightforward. Since the ownership hierarchy of exercises, concepts and interaction knowledge components are explicitly illustrated by the visual manifestations of the lessons, the implemented publishing process can quickly transform such visual hierarchy into one described in a BOP definition language. In addition, the visual manifestation also explicitly contains information required to crop the images necessary for deployment of the lessons. Finally, the representation stored in BOP definition language, as shown in the sample markup language explained above in the BOP Definition Language section, will be rendered into a learning interface. FIG. 12 illustrates the rendering of a given representation into an adaptive lesson, according to certain embodiments.

FIG. 12 shows the very same lesson 1200 after rendering and is ready for answer input 1206 in view of the coefficients 1202, 1204 of the equations shown in lesson 1200. The rendered screen bears high resemblance of the authoring screen.

### Learning Environment Interface

### Hint Request Button

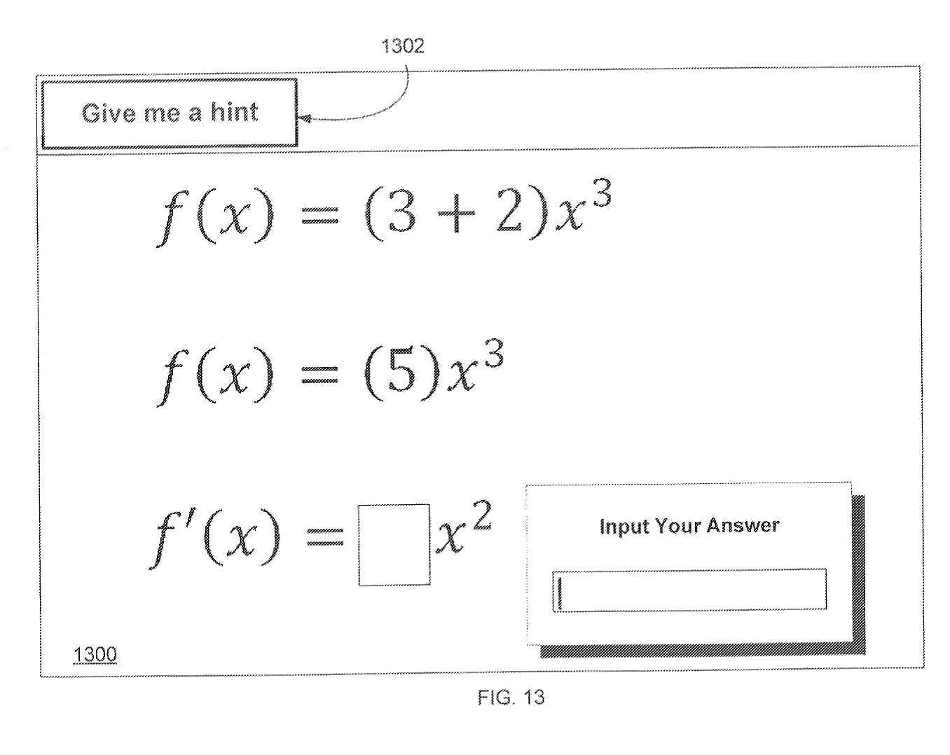

Similar to scaffolding in the lesson content, when a learner is engaged in a learning exercise, it will be helpful to provide hints on the current step that the learner is working on. FIG. 13 illustrates an example of a hint request button, according to certain embodiments. The LearnBop platform design and the CKALE paradigm includes the use of one or more “hint” button 1302 that the user/learner can interact with to request additional scaffolding on the current exercise 1300, as shown in FIG. 13.

### Modal Messaging

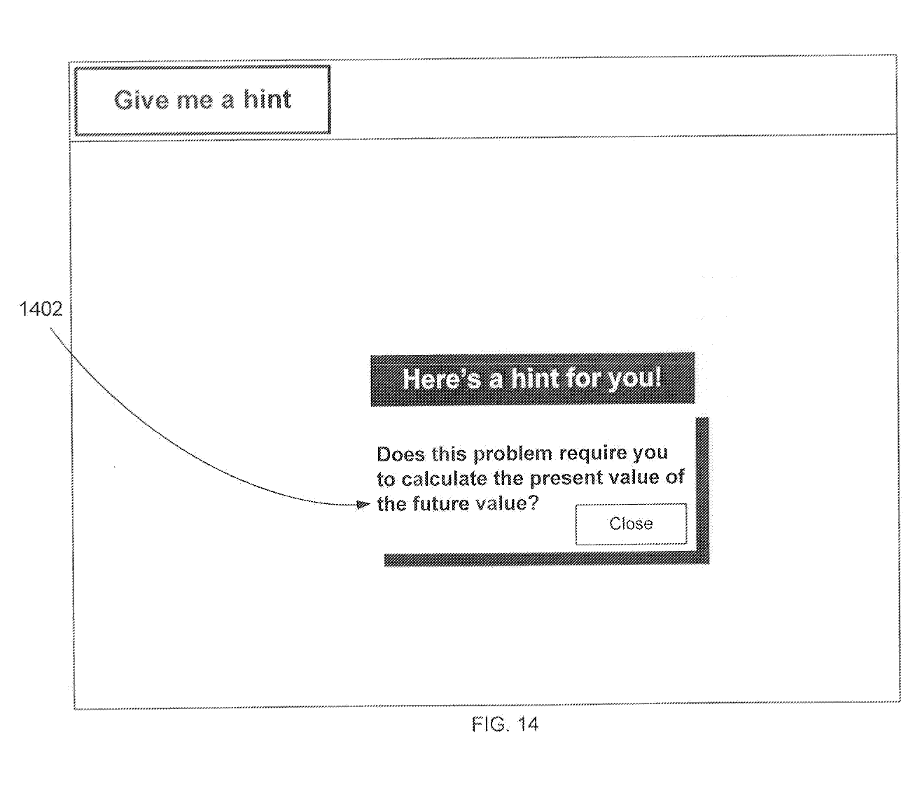

While engaged in a learning exercise, the user/learner may request a hint, may commit an error or may even require further instructions on using the interface. Therefore, a modal message box that locks the interface until the user explicitly closes the box is required to deliver information critical to the learning process. FIG. 14 illustrates the use of a modal message, according to certain embodiments. For example, FIG. 14 shows a modal message box 1402 displaying a hint for the learner.

### Progress Display

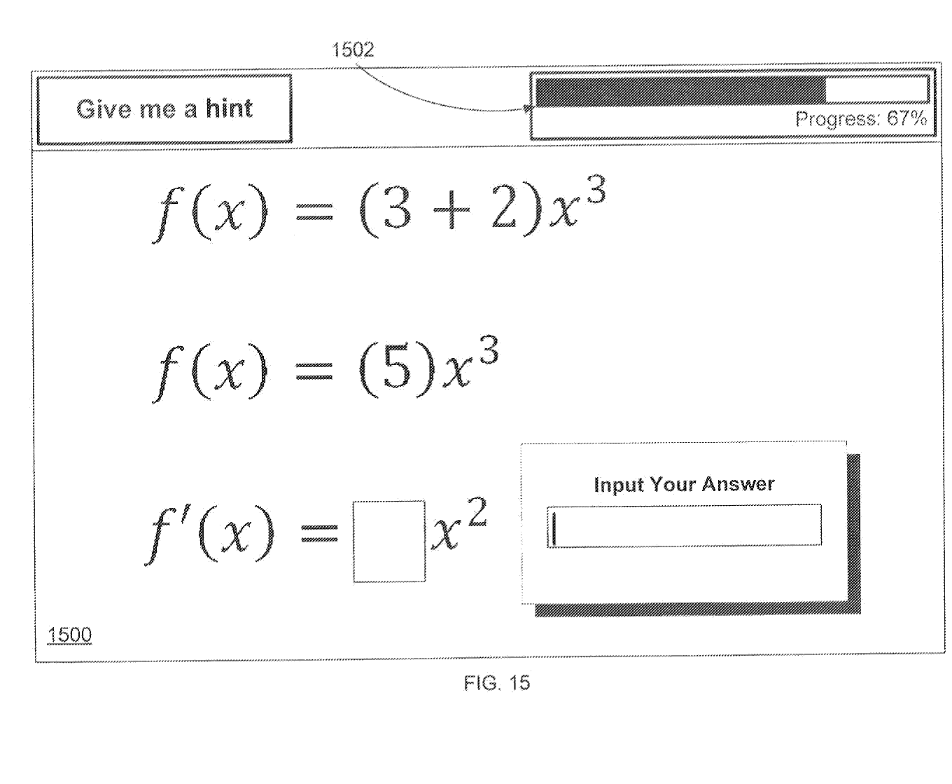

The LearnBop platform design and the CKALE paradigm include the use of a visual manifestation of learning progress to inform the user of goal achievements. FIG. 15 illustrates a progress display, according to certain embodiments. FIG. 15 illustrates a non-limiting example of an implementation of a learning progress display shown as a progress bar 1502 for exercise 1500.

### Instructional Scaffolding

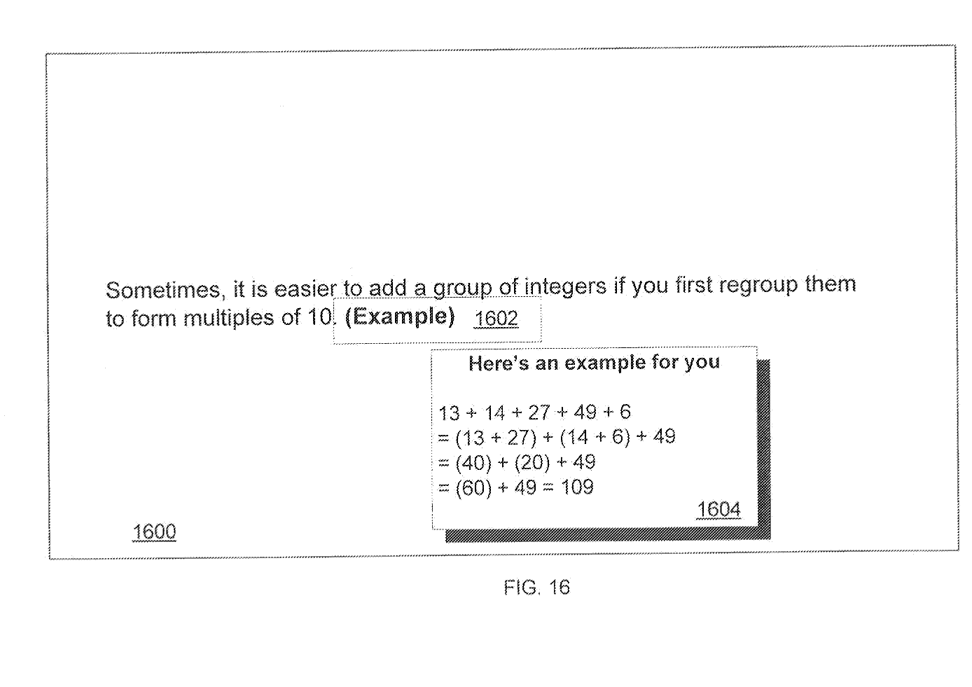

As described previously, additional scaffolding information may be added to certain parts of the lesson. FIG. 16 illustrates instructional scaffolding, according to certain embodiments. This feature is available during adaptive exercises as well. FIG. 16 shows that exercise 1600 includes additional scaffolding information 1604 that is rendered when a learner requests additional information through button 1602.

### Focus Grabber

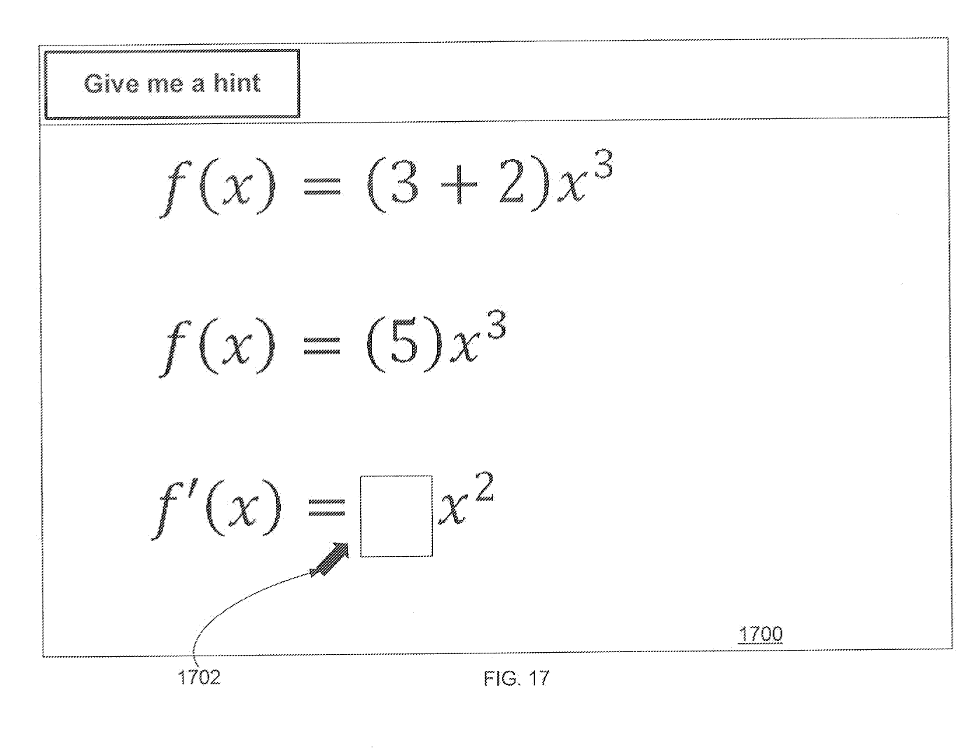

Traditional intelligent tutoring systems' interfaces are often populated by numerous software interface components, and thus are rather overwhelming for the learner to process upon first arrival. From a learning science perspective, the overload of visual information consumes more cognitive resources, leaving less memory and attention for the user to focus on the exercise/learning task. Therefore, the LearnBop platform design and the CKALE paradigm include the use of “focus grabbers” to bring learners' attention to interface components that are important to the current step in the learning process. FIG. 17 illustrates the use of focus grabbers, according to certain embodiments.

FIG. 17 shows a non-limiting implementation of a “focus grabber” in the form of a blinking arrow 1702 in exercise 1700.

### Focus-Sensitive Problem-Solving

Like the “focus grabber”, it is understood that learning is more effective when cognitive resources like attention and memory are fully allocated toward the learning task. As mentioned previously, traditional intelligent tutoring systems often have interfaces with large numbers of active interface controls.

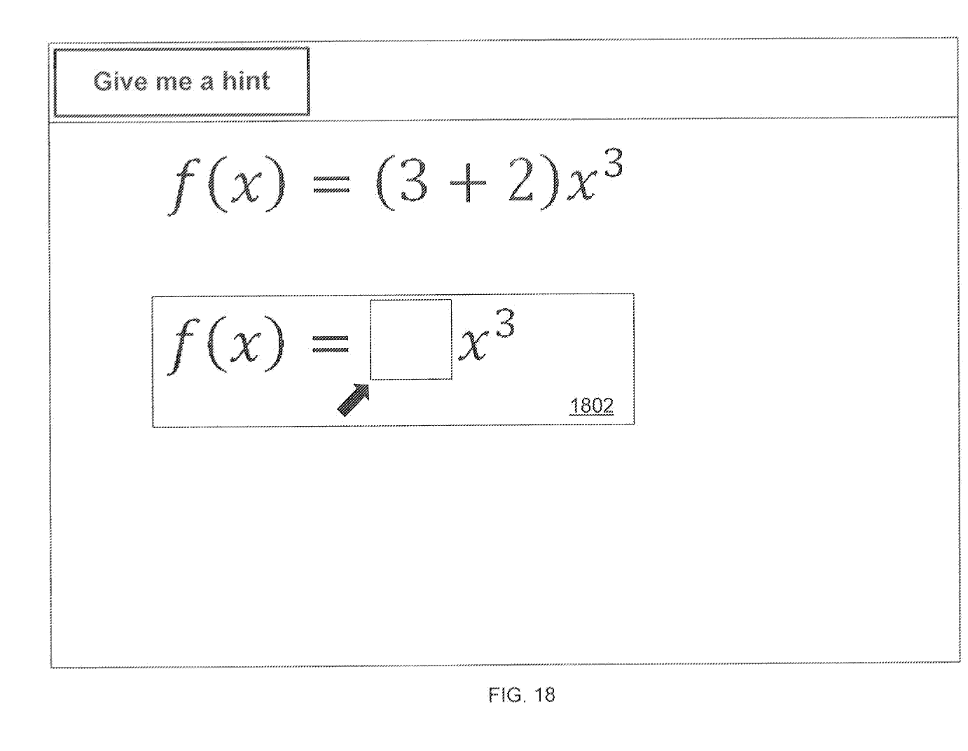

Therefore, the LearnBop platform design and the CKALE paradigm implements a learning environment that includes at least one step-wise mechanism to divide the problem into conceptual sub-components, and reveal only what is necessary for the current step in order to avoid distracting and overloading the learner with too much information. FIG. 18 illustrates Focus-Sensitive Problem-Solving Step #1, according to certain embodiments.

FIG. 18 show a non-limiting implementation of a step-wise problem-solving mechanism where the first concept/skill 1802 and its constituent steps are shown.

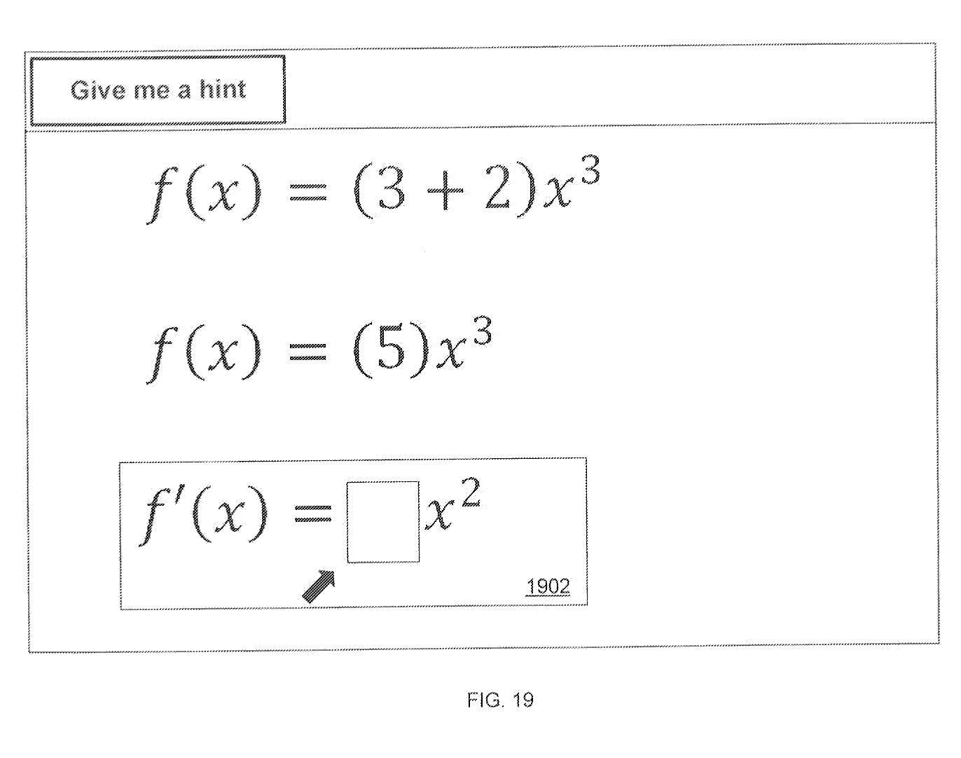

After the first concept or skill (in this case, writing out the derivative) has been completed, the system will then reveal the second concept or skill, in order to bring the learner's focus to the new sub-component of the exercise. FIG. 19 illustrates Focus-Sensitive Problem-Solving Step #2, according to certain embodiments. In FIG. 19, second concept or skill 1902 is brought to the learner's attention.

### Knowledge Discovery as a Service (Data Mining and Machine Learning)

The LearnBop platform records the following types of log events on learning, with timestamps and user identifiers:
Page Actions (a user enters or interacts with the interface)
Activation (a user clicks on a interaction knowledge component, bringing focus to the component)
Inputs (a user inputs a value as responses to the interface)
Help request (a hint or additional instructional scaffolding information was requested by the student)
Message displayed (a message, for instance, an error message, has been displayed on the interface)
Close Window (a user closes a window or a popup on the interface)
Answer is correct (the system determined the response input to be correct)
Answer is incorrect (the system determined the response input to be incorrect)
Completion (when an exercise has been fully completed)

The raw data provides a means to discover a number of ways to understand learning.

### Basic Statistics

The immediate benefit of the data is the basic statistics that include the amount of time spent on a lesson, number of hints requested, number of errors committed, as etc. The LearnBop platform provides the capability to produce aggregates, averages and other attributes of the aforementioned log events. The examples given in this section are by no means exhaustive.

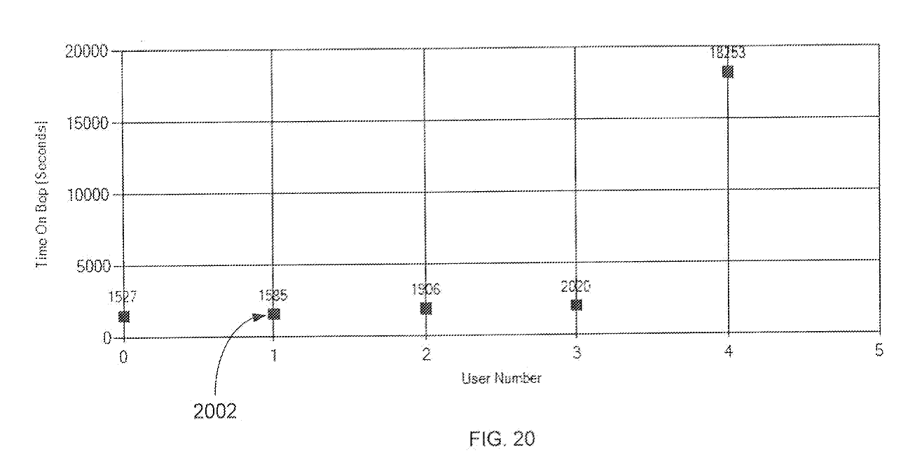

FIG. 20 is a graph illustrating the amount of time each user/learner (notated as blue squares 2002) spent on the lesson (in seconds), according to certain embodiments.

### Learning Tracing: Conditional and Correlational Analysis

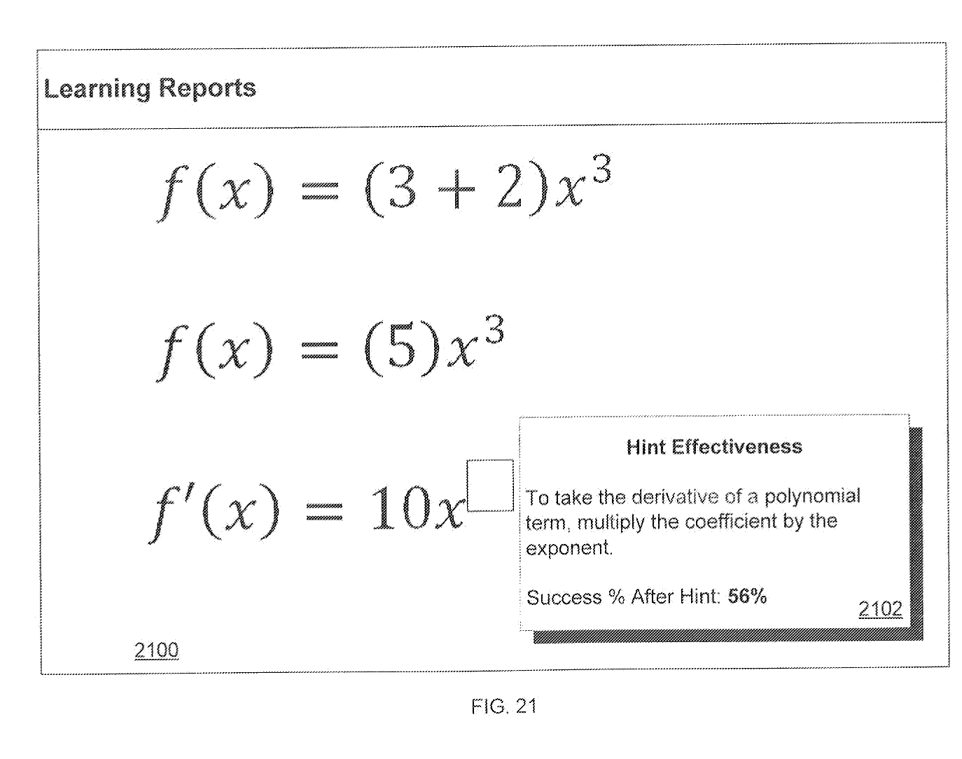

In addition to aggregates and averages of log events, the LearnBop platform also has the capacity to produce reports on conditional measures such as the effectiveness of hint messages (i.e., success rate on interaction knowledge components conditioned on hint requests), as well as correlational analysis such as success rate vs. time to help teachers understand whether students are investing meaningful study time or are they simply stuck. The LearnBop platform offers the capacity to compute conditional measures and conduct correlational analysis on aggregates, averages and other attributes of the log events in order to provide more detailed feedback on student learning. FIG. 21 illustrates a Conditional and Correlational Analysis Example—Hint Effectiveness, according to certain embodiments.

FIG. 21 shows a visualization 2100 of a step-wise problem in a lesson, and the reported success rate 2102 of response attempts after particular hints have been requested on the step.

### Motivational and Meta-Cognitive Measures

The LearnBop platform is an adaptive learning platform with an emphasis on learning science, which means the LearnBop platform augments the learning data collected with information regarding a student's meta-cognition and motivation, therefore providing possibilities of predicting future learning, something that has been extremely difficult to do in the past using just data on student performance.

The LearnBop platform augments the learning data reports with meta-cognitive and motivational information in the following ways:

### Survey

In the learning science literature, surveys such as Motivation and Strategy for Learning Questionnaire (MSLQ) have been widely used to collect student self-reported measures on goal orientation, task value, intrinsic motivation, help-seeking behavior and other motivational and meta-cognitive constructs, by means of Likert scales.

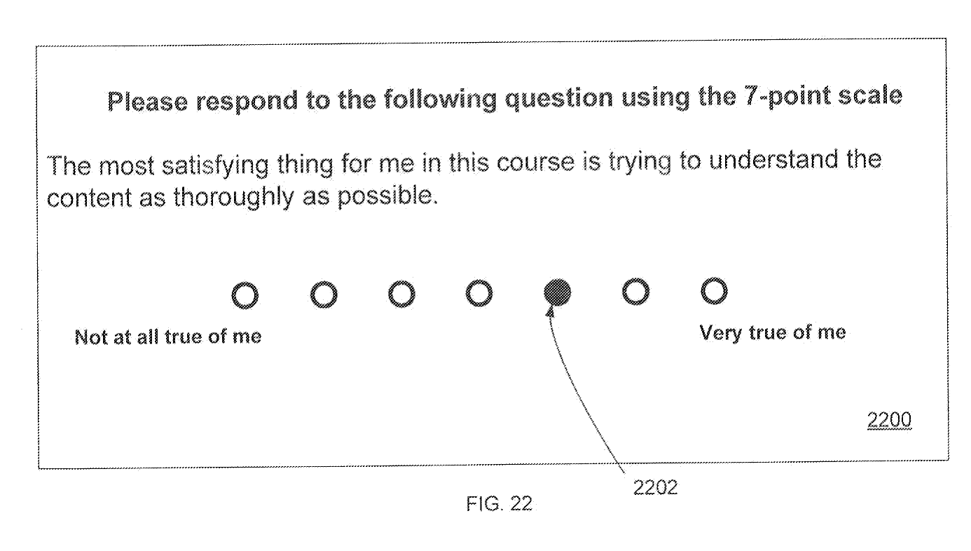

FIG. 22 illustrates a sample Motivation and Strategy for Learning Questionnaire. In FIG. 22, the MSLQ questionnaire 2200 measures Extrinsic Goal Orientation 2202.

Such survey responses may be used to create new aggregates, averages or attributes for statistical analysis mentioned previously.

### Help Seeking

As mentioned previously, the LearnBop platform provides a number of means for students to get help, including requests for hints, glossary term definitions and additional instructional scaffolding information. The usage information on all these scaffolding facilities reveal important information about students' meta-cognitive behaviors that may be used to understand how to improve students' future learning.

For example, if a student continuously enters incorrect answers and never asked for hints or other forms of help, this student is understood to be lacking in help-seeking behaviors.

Another example would be if a student consistently asks for all the hints, or inputting large numbers of answers within short periods of time, the student can be understood to be gaming the system.

Similarly, help seeking observations may also be used to create new aggregates, averages or attributes for statistical analysis mentioned previously.

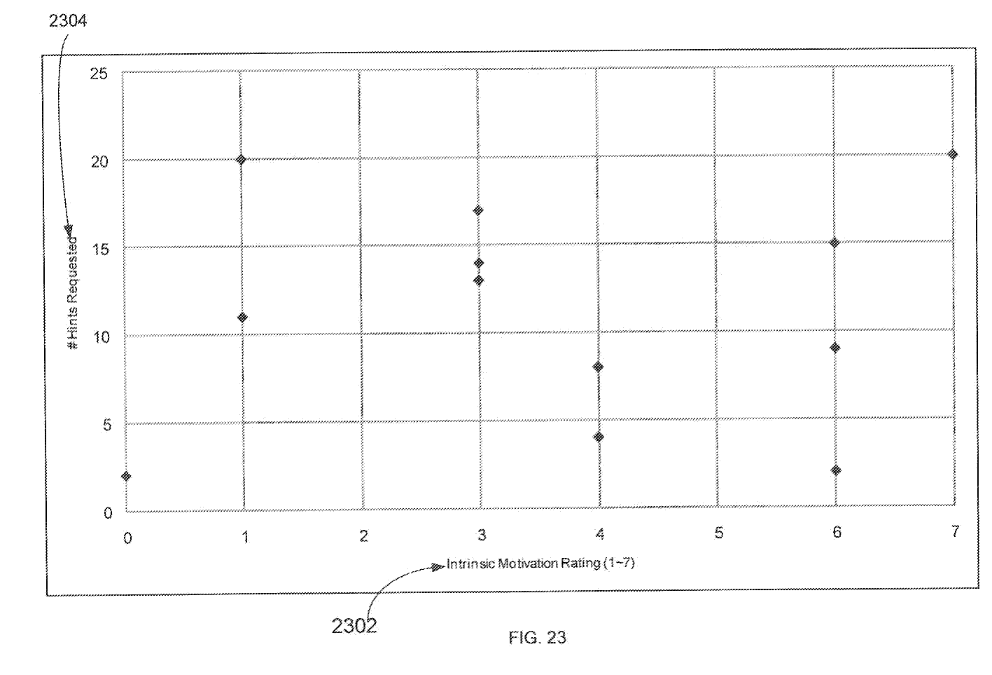

FIG. 23 illustrates a Help-Seeking Behavior Reporting Example—Hints Requests vs. Intrinsic Motivation, according to certain embodiments. FIG. 23 is a visualization of how a motivational measure such as intrinsic motivation 2302, may relate to help-seeking behavior like the number of hints requested 2304. This type of visualization is invaluable to teachers who wish to understand how they might be able to intervene inside or outside of class to increase student interest and strategy use in learning activities.

### Predictions

Predictions are made possible by performing machine learning algorithms on the aggregates, averages and attributes of log events as well as higher-level motivational and meta-cognitive constructs mentioned previously.

The following prediction models have been incorporated into the LearnBop platform design:

### Predicting Better Future Learning

By employing machine learning algorithms such as Bayesian classification, Artificial Neural Networks and other viable alternatives, prediction models based on features from learning data and motivational/meta-cognitive constructs such as time spent on lesson and help-seeking behavior, are developed to predict student performance or for skill mastery.

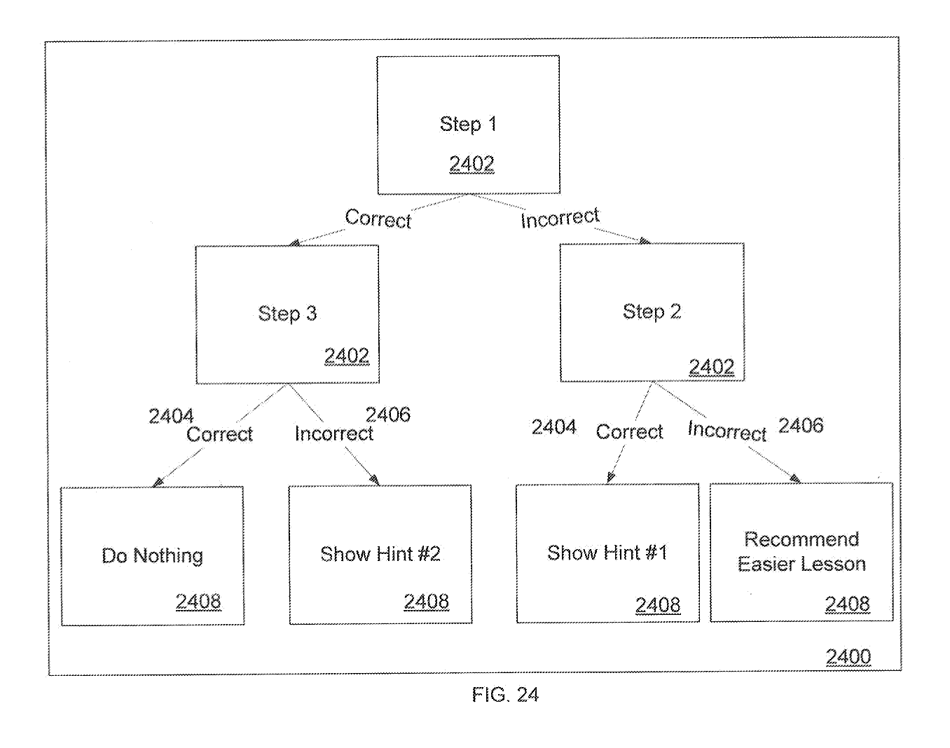

FIG. 24 illustrates Predicting Future Help Needs—Decision Tree, according to certain embodiments. FIG. 24 shows a visualization of a learning optimization/prediction model implemented as a decision tree 2400 where depending on what steps 2402 of the problem the student answers correctly 2404 or incorrectly 2406, the model will recommend additional hints 2408 or suggest that student try an easier problem.

### Causal Search

Another interesting class of machine learning algorithms is causal model search algorithms like PC, FCI, GES, LINGAM. By performing causal model search on the aggregates, averages and attributes mentioned previously, the LearnBop system can create causal models that estimate causal relationships between different measures and constructs.

For instance, if we have three measures/constructs such as performance, goal orientation, and time on lesson, there are many different causal models that may arise. One possible model may be that the students' goal orientation will affect how much effort they put in, which will be manifested as time on lesson and performance. Therefore in this model, goal orientation is likely to be the cause of time on lesson and performance. However it may also be the case that students' time on lesson and performance affects their goal orientation in that if students are able to complete the lessons correctly in a short amount of time, they may set a goal to complete the lesson. Therefore in the second model, both time on lesson and performance are likely to be causes of goal orientation.

By providing visualized causal models, the LearnBop platform is providing in-depth analysis of learning that unveil insights to how teachers may be able to assist students both in electronic and in physical settings.

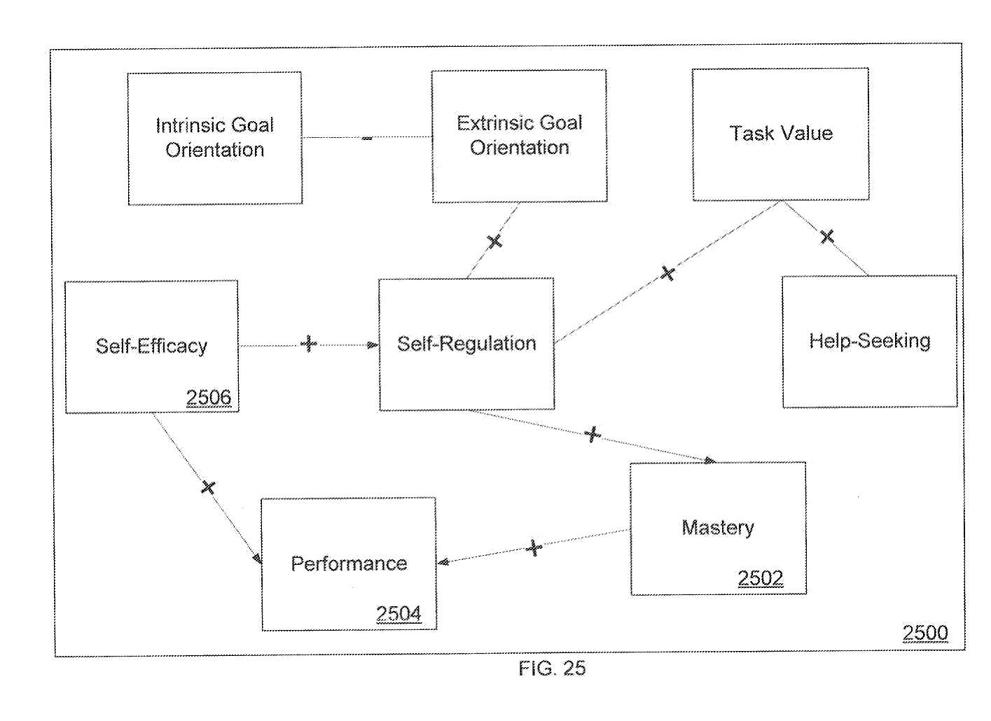

FIG. 25 illustrates a sample Causal Model of Learning, Motivation and Help-Seeking, according to certain embodiments. FIG. 25 shows a visualization of a causal model 2500.

As shown in FIG. 25, some relationships such as the ones between Mastery 2502 and Performance 2504, and between Self-Efficacy 2506 and Performance 2504, the direction of causation have been determined. For the other relationships that cannot be determined by causal search algorithms, the visualization will at least indicate whether the two constructs or variables are positively or negatively correlated.

### Adaptive Learning as a Service (Ubiquitous Learning)

Another important feature of LearnBop's flexibility is that it allows users/authors to create and deploy the adaptive lessons once, and allows access to the same learning environment everywhere, whether it is on personal computers, on mobile devices or on offline devices without network connectivity.

A knowledge definition written in BOP definition language is created on the server, along with necessary resource files (e.g., images, audio, video, etc) to deliver a full adaptive lesson. There are three types of clients that can be developed and used to access the adaptive lessons created on LearnBop:

### Web-Based (Browser-Based) Client

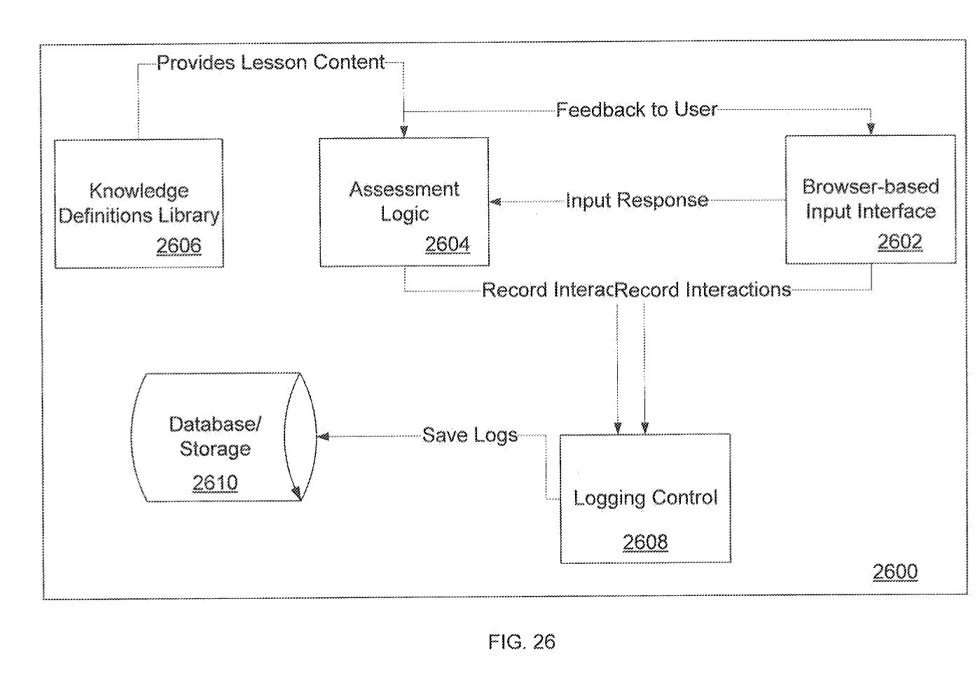

The web-based/browser-based client is the default LearnBop client that can be accessed by any device with network connectivity and an up-to-date web browser. The web-based client offers pre-compiled learning interfaces for each adaptive lesson, full logging service for all learning behaviors and complete learning reports with visualizations. FIG. 26 illustrates a Web-based/Browser-based client design, according to certain embodiments. FIG. 26 shows data flow of the system 2600 per interaction knowledge component. System 2600 includes a browser-based input interface 2602, an assessment logic 2604, a knowledge definitions library 2606, a logging control 2608 and database storage 2610, according to certain embodiments.

### Service-Based (Mobile Device) Client

Some mobile devices may not have browsers that support modern scripting (e.g. AJAX) and style sheet (e.g. CSS) technologies, required to use the web-based client. The alternative is to use a service-based client.

According to certain embodiments, the LearnBop platform comes with a web service that provides the following services.

### Authentication

This service authenticates the user and grants access to the subsequent services.

### Lesson Search

(Requires authentication) This service returns a list of lessons that match certain search requirements (e.g., keywords, rating).

### Adaptive Learning

(Requires authentication) Once the user enters an adaptive lesson, the client can connect to the rest of the web service to request information on interaction knowledge components, submit responses to interaction knowledge components and receive responses regarding whether or not the submitted responses were correct.

### Logging

(Passive) Since the web service is hosted as a part of the LearnBop platform, all learning behaviors that were observable by the web service will be logged. The client does not actively control logging.

### Data Reports

(Requires authentication) The user may retrieve statistics on learning from the web service.

In overview, the service-based architecture of the LearnBop platform provides mobile devices without proper browsers the freedom to implementation visual manifestations of interaction knowledge components (for instance, the service-based client need to provide interface components for multiple choice), and still have access to all the adaptive learning content and associated resources (e.g., images, videos, audios) like the traditional web-based clients.

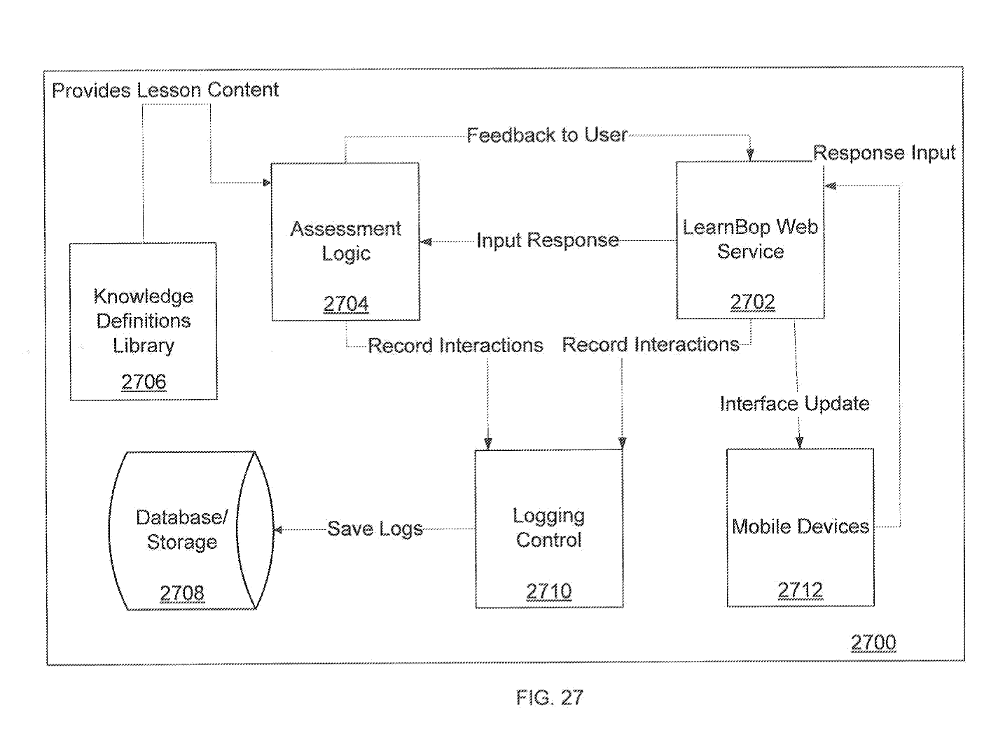

In other words, for devices that do not have adequate browser support, the LearnBop platform web services will provide all the information necessary to create a customized third party client for learning and for reporting. FIG. 27 illustrates a Service-based Client Design, according to certain embodiments. FIG. 27 shows data flow per interaction knowledge component for a service-based client. System 2700 includes web service 2702, assessment logic 2704, knowledge definitions library 2706, database storage 2708, logging control 2710 and mobile devices 2712.

### Offline Client

Under some circumstances, users may not have access to devices with network connectivity. For such situations, the LearnBop platform offers a utility to generate a standalone lesson package for one adaptive lesson that can be accessed by a Javascript and CSS-enabled browser. Since without network connectivity, content changes to the adaptive lesson will not be reflected in the standalone package, learning behaviors will not be logged to the server and thus learning reports will not be available to the user. Therefore, the use of the offline client is strong discouraged.

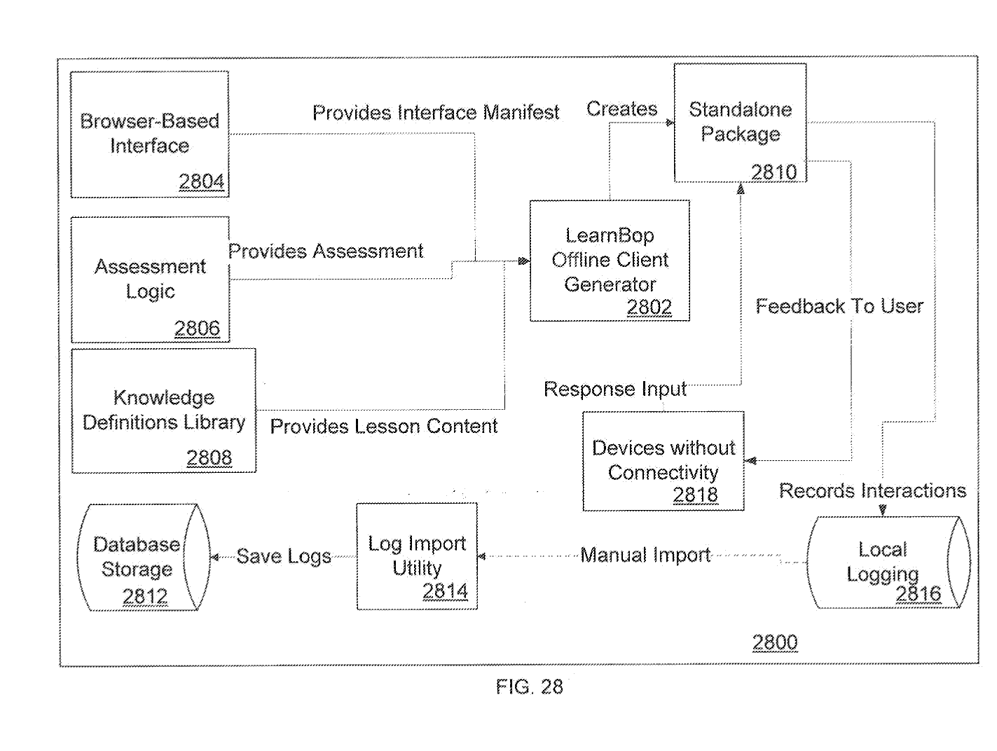

The standalone lesson package does, however, include a local logging utility that generates a log file that can be manually retrieved and uploaded to the server at a later date. FIG. 28 illustrates an Offline Client Design, according to certain embodiments.

FIG. 28 shoes the data flow per interaction knowledge component for an offline client. System 2800 of FIG. 28 includes offline client generator 2802, browser based interface 2804, assessment logic 2806, knowledge definitions library 2808, standalone package 2810, database storage 2812, log import utility 2814, local logging 2816 and devices 2818 without connectivity.

We claim:

1. A computer-implemented method of providing a platform for creating online interactive learning experience, the method comprising:
providing a plurality of computer-implemented interaction knowledge components as building blocks to build a plurality of concepts, one or more of which can be scaffolded to build an online interactive and adaptive lesson, wherein a respective interaction knowledge component of the plurality of interaction knowledge components is an independent severable unit of instruction and includes assessment logic and wherein the plurality of interaction knowledge components and concepts are re-usable and regroupable to build different online interactive and adaptive lessons.

2. The method of claim 1, wherein a respective interaction knowledge component further comprises an input interface for providing a user one or more audio, video or other media prompts and interface components comprising one or more of: textboxes, drop-down lists, radio buttons, and drag-and-drop lists.

3. The method of claim 1, wherein the assessment logic evaluates correctness of user input and provides feedback message based on the user input.

4. The method of claim 2, wherein a respective interaction knowledge component further comprises a knowledge definition component that provides content for populating prompt and input controls on the input interface.

5. The method of claim 1, further comprises using a high level mark up definition language to initialize, order, chain and populate interaction knowledge components.

6. The method of claim 1, wherein a respective concept can be divided and into its respective interaction knowledge components and regrouped with other interaction knowledge components for reuse.

7. The method of claim 1, further comprises providing a computer-implemented online automated curriculum designer to allow an instructor to create the online interactive and adaptive lesson for one or more users, wherein the online automated curriculum designer provides feedback to the instructor based on concept data aggregated from at least a subset of adaptive lessons created by a plurality of instructors, the feedback comprising identification of missing concepts or insufficiency of concepts of the adaptive lesson that the instructor is creating.

8. The method of claim 1, further comprises using a computer-implemented visual authoring tool to allow creation of complex adaptive lessons without requiring design or programming experience.

9. The method of claim 8, further comprises using computer-implemented conceptual labeling including color-coded labels to select a portion of a presentation, to demonstrate a concept or skill.

10. The method of claim 8, further comprises using computer-implemented interaction component designation for transforming a created representation into an adaptive problem for a respective user.

11. The method of claim 1, further comprises using computer-implemented visual forms and user interface controls for populating information associated with the respective interaction knowledge components.

12. The method of claim 1, further comprises publishing hierarchical visual content using a high level mark up definition language.

13. The method of claim 1, further comprises implementing a hint button for allowing a user to interact with the adaptive lesson by requesting a hint for solving a problem in the adaptive lesson.

14. The method of claim 1, further comprises providing graphical modal messages when a user requires further hints to solve a problem in the adaptive lesson.

15. The method of claim 1, further comprises providing a visual display indicating a user's learning progress.

16. The method of claim 1, further comprises using computer-implemented graphical focus grabbers to bring a user's attention to interface components that are important in the learning process.

17. The method of claim 1, further providing a logical curriculum designer for:
allowing lesson content scaffolding using rich-text and multimedia content; and
allowing instructional scaffolding that provides context-specific learning content and messages to the us.
